(19) United States
(12) Patent Application Publication
(10) Pub. No.: US 2025/0383817 A1
(43) Pub. Date: Dec. 18, 2025

(54) ACCESS OPERATIONS ON WEAK WORD LINES

(71) Applicant: Micron Technology, Inc., Boise, ID (US)

(72) Inventors: Thibash Rajamani Balakrishnan, Bangalore (IN); Amiya Banerjee, Bangalore (IN)

(21) Appl. No.: 19/222,943

(22) Filed: May 29, 2025

Related U.S. Application Data
(60) Provisional application No. 63/659,446, filed on Jun. 13, 2024.

(51) Int. Cl. G06F 3/06

(52) U.S. Cl. CPC G06F 3/0659; G06F 3/0604; G06F 3/0679

(57) ABSTRACT

Methods, systems, and devices for access operations on weak word lines are described. A memory system may receive a command and may determine that the command is associated with a word line having a characteristic that satisfies a threshold value. If the command is a first type, such as a programming command (e.g., a write command), the memory system may perform the programming command using a first type of write operation (of a plurality of types of write operations). If the command is a second type, such as a read operation, the memory system may perform the read operation using a first type of read operation (of a plurality of types of read operations).

### CROSS REFERENCE

The present Application for Patent claims priority to U.S. Patent Application No. 63/659,446 by Balakrishnan et al., entitled “ACCESS OPERATIONS ON WEAK WORD LINES,” filed Jun. 13, 2024, which is assigned to the assignee hereof, and which is expressly incorporated by reference in its entirety herein.

### TECHNICAL FIELD

The following relates to one or more systems for memory, including access operations on weak word lines.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports access operations on weak word lines in accordance with examples as disclosed herein.

FIG. 2 shows an example of a process that supports access operations on weak word lines in accordance with examples as disclosed herein.

FIG. 3 shows a block diagram of a memory system that supports access operations on weak word lines in accordance with examples as disclosed herein.

FIGS. 4 and 5 show flowcharts illustrating a method or methods that support access operations on weak word lines in accordance with examples as disclosed herein.

### DETAILED DESCRIPTION

A memory system may include one or more blocks of memory cells. In some cases, a block may include memory cells organized into rows (e.g., pages) and columns (e.g., strings). For example, memory cells in a same page may share (e.g., be coupled with) a common word line, and memory cells in a same string may share (e.g., be coupled with) a common digit line. Some word lines of the memory system may have different characteristics than others. For example, some word lines, which may be referred to as “weak” word lines, may be associated with a relatively higher bit error rate (BER) or charge loss than other word lines. Data stored to memory cells associated with weak word lines may experience relatively higher BERs (among other challenges), which may result in the memory system including additional error correction capabilities. Such additional correction capabilities may add cost and size to the memory system, which may be undesirable. Thus, a memory system configured to improve the endurance of weak word lines may be desirable.

A memory system configured to improve the endurance of weak word lines without adding additional error correction capabilities is described herein. In some examples, if a command is received, a memory system may determine whether the command is associated with a relatively weak word line (e.g., a word line associated with a relatively higher BER or charge loss than other word lines). In some instances, an indication of weak word lines may be stored to the memory system based on one or more testing operations during a manufacturing operation. If the command is associated with a weak word line, the memory system may select a type of operation based on a type of the command, such as whether the command is a programming command (c.g., a write) or a read command. For example, if the command is a programming command, the memory system may write data to the associated memory cells by increasing the programming time (e.g., by reducing the pulse width to a smaller pulse width and the quantity of pluses applied to the memory cells), which may improve the stability of the data. If the command is a read command, the memory system may read the data using high reliability decoding (HRD), which may correct errors (c.g., bit-flips) associated with weak word lines. Accordingly, the methods described herein may improve the endurance of weak word lines without adding additional error correction capabilities, among other advantages.

In addition to applicability in memory systems as described herein, techniques for access operations on weak word lines may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving the endurance of weak word lines, which may improve the system's overall performance without adding additional error correction capabilities, among other benefits.

Features of the disclosure are illustrated and described in the context of a system. Features of the disclosure are further illustrated and described in the context of a process, block diagram, and flowcharts.

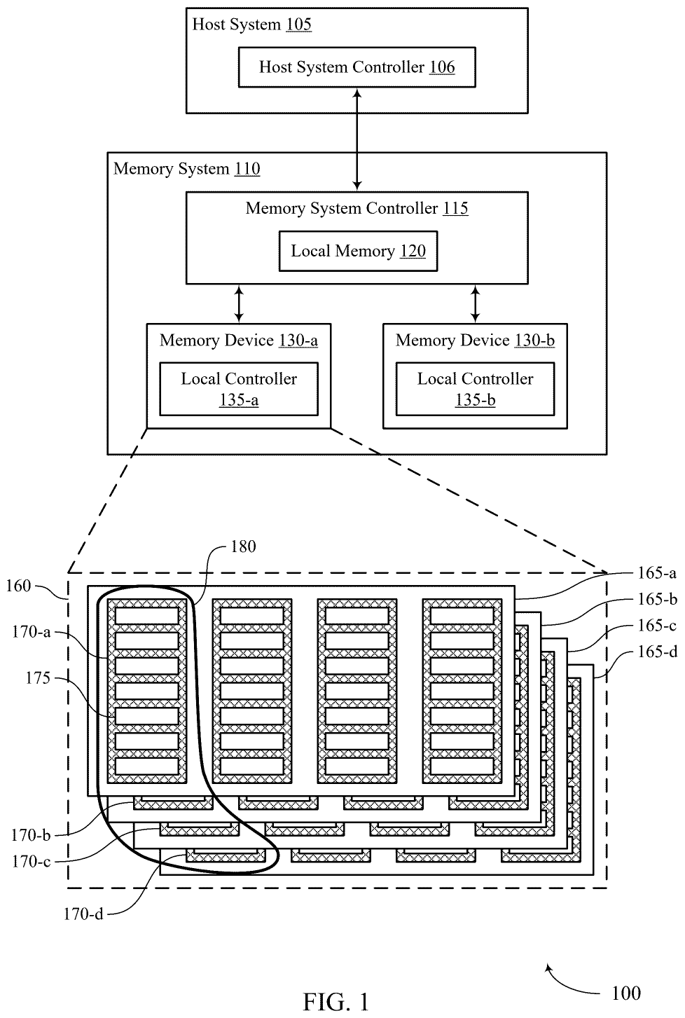

FIG. 1 shows an example of a system 100 that supports access operations on weak word lines in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (c.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (c.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (c.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (c.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (c.g., hard-coded) logic to perform the operations ascribed herein to the memory system controller 115. The memory system controller 115 may be or include a microcontroller, special purpose logic circuitry (c.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (c.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (c.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (c.g., NAND flash) memory, ROM, phase change memory (PCM), self-selecting memory, other chalcogenide-based memories, ferroelectric random access memory (FeRAM), magneto RAM (MRAM), NOR (c.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (c.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (c.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The memory system 110 may receive a command from the host system 105. For example, the memory system controller 115 may receive the command and may determine whether the command is associated with a relatively weak word line. In some instances, an indication of weak word lines may be stored to the memory system 110 (e.g., to the local memory 120) based on one or more testing operations during a manufacturing operation. If the command is associated with a weak word line, the memory system controller 115 may select a type of operation based on whether the command is a programming command (c.g., a write) or a read command. For example, if the command is a programming command, the memory system controller 115 may write data to the associated memory cells by increasing the programming time (e.g., by reducing the pulse width and the quantity of pluses applied to the memory cells), which may improve the stability of the data. If the command is a read command, the memory system controller 115 may read the data using high reliability decoding (HRD), which may correct errors (e.g., bit-flips) associated with weak word lines. Accordingly, the methods described herein may improve the endurance of weak word lines without adding additional error correction capabilities to the memory system 110.

The system 100 may include any quantity of non-transitory computer readable media that support access operations on weak word lines. For example, the host system 105 (c.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (c.g., by a host system controller 106), by the memory system 110 (e.g., by a memory system controller 115), or by a memory device 130 (c.g., by a local controller 135), may cause the host system 105, the memory system 110, or the memory device 130 to perform associated functions as described herein.

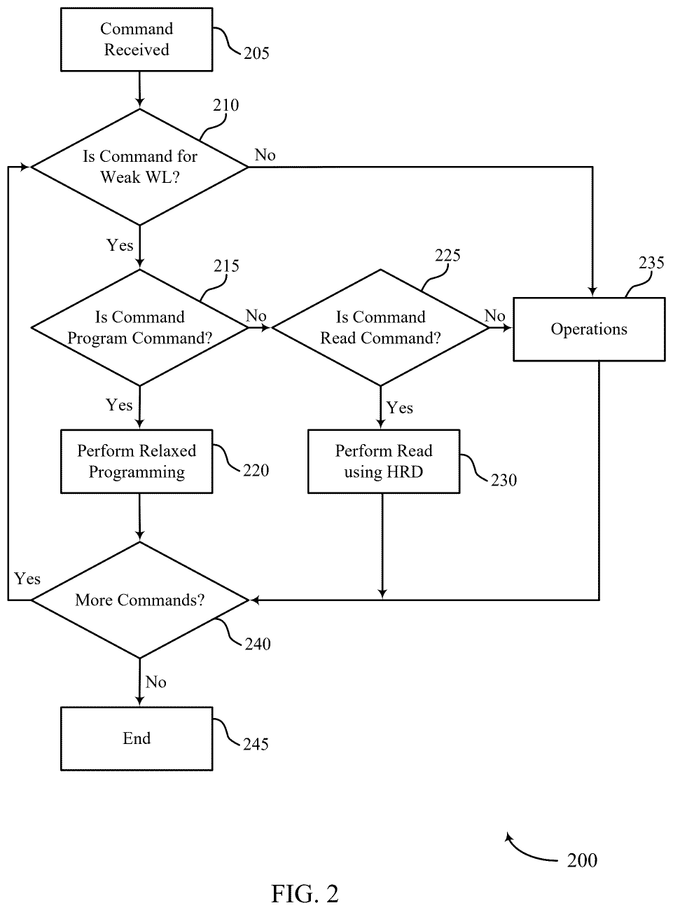

FIG. 2 shows an example of a process 200 that supports access operations on weak word lines in accordance with examples as disclosed herein. In some instances, the process 200 may be performed at or by the memory system 110 described with reference to FIG. 1. For example, the process 200 may illustrate operations performed based on the memory system 110 receiving a command from the host system 105. In some instances, the operations described may be performed by the memory system controller 115. The methods and operations described with reference to the process 200 may improve the endurance of weak word lines of a memory system without adding additional error correction capabilities (c.g., additional error correction circuitry or components).

Alternative examples of the following may be implemented. Some operations are performed in a different order than described or are not performed at all. In some cases, operations may include additional features not mentioned below, or further operations may be added. Although a host system and a memory system are described as performing the operations of the process 200, some aspects of some operations may also be performed by one or more other systems or devices.

Aspects of the process 200 may be implemented by one or more controllers, among other components. Additionally, or alternatively, aspects of the process 200 may be implemented as instructions stored in one or more memories. For example, the instructions, when executed by one or more controllers, may cause the one or more controllers (or a device or a system) to perform the operations of the process 200.

At 205, a command may be received. In some instances, the command may be received by a memory system controller or another component of a memory system. The command may be issued by a host system or another device that is coupled with or otherwise in communication with the memory system. In some instances the command may be received via an interface of the memory system. The command may be associated with reading data from or writing data to one or more non-volatile memory cells of the memory system. In some examples, the command may be associated with a SLC, MLC, TLC, or QLC.

At 210, it may be determined whether the command is associated with a relatively weak word line. In some instances, a memory system controller or another component of the memory system may determine whether the command is associated with a relatively weak word line. Whether the command is associated with a relatively weak word line may be based on a word line associated with the command and/or a characteristic of the word line. For example, the command may include an address that is associated with a word line. The memory system controller may identify the word line based on receiving the address.

The characteristic of the word line may be or may include its BER and/or its charge loss (among other examples). That is, cach word line of a memory system may be associated with a respective BER and a respective charge loss. A respective BER may be the quantity of errors associated with the word line over a duration, and a respective charge loss may be the amount of voltage lost by a word line over a duration. In some instances, the memory system controller may compare the characteristic of the word line to a threshold value. For example, the memory system controller may compare the BER of a word line to the threshold value. If the BER satisfies the threshold value (e.g., is above the threshold value), then the word line may be considered a weak word line. Additionally, or alternatively, the memory system controller may compare the charge loss of a word line to the threshold value. If the charge loss satisfies the threshold value (e.g., is above the threshold value), then the word line may be considered a weak word line. In other examples, if the BER or charge loss does not satisfy the threshold value, the word line may not be considered a weak word line.

In some instances, the BER and the charge loss for respective word lines may be stored to the memory system. For example, indications of the BER and charge loss for respective word lines may be stored to a register, volatile memory (e.g., SRAM), or a portion of non-volatile memory. In other examples, an indication of whether a word line is weak may be generated and stored (e.g., to volatile or non-volatile memory) during a testing phase of a manufacturing operation. If a command is received, the memory system controller may access (e.g., read) the portion of the memory system where the indications are stored to determine whether the word line is weak. In some instances, a word line may weaken over time, thus a first time a word line is accessed it may not be considered weak, but an Nth time it is accessed it may be considered weak.

If the memory system controller determines that the word line is not weak, the process 200 may continue to 235. If the memory system controller determines that the word line is weak, the process 200 may continue to 215.

At 215, it may be determined whether the command is of a first type, such as a program command. In some examples, a memory system controller or another component of the memory system may determine whether the command is a program command (c.g., a write command). If the memory system controller determines that the command is not a program command, the process 200 may continue to 215. If the memory system controller determines that the command is a program command, the process 200 may continue to 212.

At 220, a relaxed programming operation may be performed. In some examples, a memory system controller or another component of the memory system may perform the relaxed programming operation on the word line associated with the programming command. As used herein, a relaxed programming operation may refer to a programming operation (c.g., a write operation) that is performed using a relatively longer programming time. For example, the programming pulse may have a reduced width and an increased quantity of pulses relative to programming pulses applied to memory cells of non-weak word lines. Applying a programming pulse having a reduced width an increased quantity of pulses may result in the distribution (e.g., the cell voltage distribution (CVD)) of the associated memory cells having relatively “sharp” peaks. This may allow for different logic states to be more easily distinguished, and the stability of the programmed data may be improved.

To perform the relaxed programming operation, the memory system controller may include an indication in the prefix of a write command. For example, the memory system controller may issue an internal command (e.g., an internal write command) that includes one or more bits set to a value (or values) that indicate to use the relaxed programming operation. In some instances, any quantity of bits may be used to indicate the relaxed programming operation, and the bits may be included in any position of the internal command. After the relaxed programming operation is performed, the process 200 may continue to 240.

At 225, it may be determined whether the command is of a second type, such as a read command. In some examples, a memory system controller or another component of the memory system may determine whether the command is a read command. If the memory system controller determines that the command is not a read command, the process 200 may continue to 235. If the memory system controller determines that the command is a read command, the process 200 may continue to 230.

At 230, a read operation may be performed using HRD. In some instances, a memory system controller or another component of the memory system may perform the read operation on the word line associated with the programming command using HRD. HRD make take relatively longer to perform than high efficiency decoding (HED). As used herein, HRD may refer to a decoding operation, that utilizes a decoding engine of the memory system, that is able to detect and correct a relatively large quantity of errors but takes a relatively longer time to perform. HED may refer to a decoding operation, that uses the same or a different decoding engine of the memory system, that is able to detect and correct a relatively smaller quantity of errors but takes a relatively shorter duration to perform. HED may be performed on non-weak word lines to save time, as these word lines are less-likely to be associated with high BERs, and HRD may be performed on weak word lines, as these word lines are more likely to be associated with high BERs.

To perform the read operation using HRD, the memory system controller may include an indication in the prefix of a read command. For example, the memory system controller may issue an internal command (e.g., an internal read command) that includes one or more bits set to a value (or values) that indicate to use the HRD. In some instances, any quantity of bits may be used to indicate the HRD, and the bits may be included in any position of the internal command. After the HRD is performed, the process 200 may continue to 240.

At 235, various operations may be performed. In some instances, a memory system controller or another component of the memory system may perform the various operations. As used herein, the various operations may refer to operations performed on non-weak word lines. For example, data may be written to memory cells of non-weak word lines using a relatively shorter programming pulse than the programming pulse used for memory cells of weak word lines. The programming pulse may have an increased width and a reduced quantity of pulses relative to the programming pulse used for memory cells of weak word lines.

Additionally, or alternatively, data may be read from memory cells of non-weak word lines using HED. HED may be relatively faster than HRD and may be used because non-weak word lines may be associated with a generally lower BER. After performing either a read operation or a write operation, the process 200 may continue to 240.

At 240, it may be determined whether more commands have been received. In some instances, a memory system controller or another component of the memory system may determine whether one or more additional commands have been received (e.g., have been received in a command queue of the memory system). If one or more commands have been received, the process 200 may continue to 210 and may effectively start over. If no additional commands have been received, the process may continue to 245 and end. By performing relaxed programming operations and read operations using HRD, the endurance of weak word lines may be improved without adding additional error correction capabilities to the associated memory system.

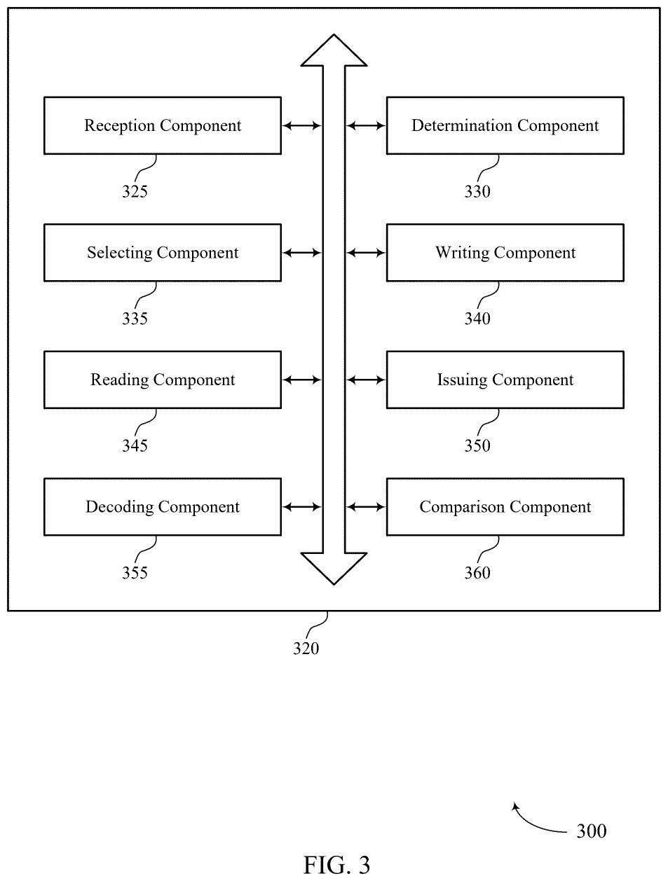

FIG. 3 shows a block diagram 300 of a memory system 320 that supports access operations on weak word lines in accordance with examples as disclosed herein. The memory system 320 may be an example of aspects of a memory system as described with reference to FIGS. 1 and 2. The memory system 320, or various components thereof, may be an example of means for performing various aspects of access operations on weak word lines as described herein. For example, the memory system 320 may include a reception component 325, a determination component 330, a selecting component 335, a writing component 340, a reading component 345, an issuing component 350, a decoding component 355, a comparison component 360, or any combination thereof. Each of these components, or components of subcomponents thereof (e.g., one or more processors, one or more memories), may communicate, directly or indirectly, with one another (c.g., via one or more buses).

The reception component 325 may be configured as or otherwise support a means for receiving a write command including data to be written to one or more multiple-level memory cells associated with a word line of the memory system. The determination component 330 may be configured as or otherwise support a means for determining whether a characteristic associated with the word line satisfies a threshold value in response to receiving the write command. The selecting component 335 may be configured as or otherwise support a means for selecting a first type of write operation from a plurality of types of write operations in response to determining that the characteristic associated with the word line satisfies the threshold value, where the first type of write operation includes a smaller pulse width and a greater quantity of pulses relative to a second type of write operation of the plurality of types of write operations. The writing component 340 may be configured as or otherwise support a means for writing the data to the one or more multiple-level memory cells using the first type of write operation.

In some examples, the reception component 325 may be configured as or otherwise support a means for receiving a first read command for the data written to the one or more multiple-level memory cells. In some examples, the selecting component 335 may be configured as or otherwise support a means for selecting a first type of read operation from a plurality of types of read operations in in accordance with the characteristic associated with the word line satisfying the threshold value, where the first type of read operation includes a first level of decoding that is greater than a second level of decoding associated with a second type of read operation. In some examples, the reading component 345 may be configured as or otherwise support a means for reading the data from the one or more multiple-level memory cells using the first type of read operation.

In some examples, the determination component 330 may be configured as or otherwise support a means for determining that the characteristic associated with the word line fails to satisfy the threshold value. In some examples, the selecting component 335 may be configured as or otherwise support a means for selecting the second type of write operation in response to determining that the characteristic associated with the word line fails to satisfy the threshold value, where the second type of write operation includes a larger pulse width and a lesser quantity of pulses relative to the first type of write operation. In some examples, the writing component 340 may be configured as or otherwise support a means for writing the data to the one or more multiple-level memory cells using the second type of write operation.

In some examples, the reception component 325 may be configured as or otherwise support a means for receiving a second read command for the data written to the one or more multiple-level memory cells. In some examples, the selecting component 335 may be configured as or otherwise support a means for selecting a second type of read operation from a plurality of types of read operations in in accordance with the characteristic associated with the word line failing to satisfy the threshold value, where the second type of read operation includes a second level of decoding that is lesser than a first level of decoding associated with a first type of read operation. In some examples, the reading component 345 may be configured as or otherwise support a means for reading the data from the one or more multiple-level memory cells using the second type of read operation.

In some examples, to support selecting the first type of write operation, the issuing component 350 may be configured as or otherwise support a means for issuing, by the memory system, a command to write the data to the one or more multiple-level memory cells using the first type of write operation.

In some examples, the characteristic associated with the word line includes a bit-error rate associated with the word line, or a charge loss associated with the word line, or both.

In some examples, to support determining whether the characteristic associated with the word line satisfies the threshold value, the reading component 345 may be configured as or otherwise support a means for reading a value from a register of a volatile memory of the memory system.

In some examples, to support determining whether the characteristic associated with the word line satisfies the threshold value, the comparison component 360 may be configured as or otherwise support a means for comparing the bit-error rate associated with the word line to the threshold value, where the threshold value is associated with a quantity of bit-error rates. In some examples, to support determining whether the characteristic associated with the word line satisfies the threshold value, the comparison component 360 may be configured as or otherwise support a means for comparing the charge loss associated with the word line to the threshold value, where the threshold value is associated with a change in electrical charge over time.

In some examples, the data is written to the one or more multiple-level memory cells using the first type of write operation during a first duration that is greater than a second duration associated with writing data to the one or more multiple-level memory cells using the second type of write operation.

In some examples, the one or more multiple-level memory cells include triple-level cells (TLCs) or quad-level cells (QLCs).

In some examples, the reception component 325 may be configured as or otherwise support a means for receiving a read command including data to be read from one or more multiple-level memory cells associated with a word line of the memory system. In some examples, the determination component 330 may be configured as or otherwise support a means for determining whether a characteristic associated with the word line satisfies a threshold value in response to receiving the read command. In some examples, the selecting component 335 may be configured as or otherwise support a means for selecting a first type of read operation from a plurality of types of read operations in response to determining that the characteristic associated with the word line satisfies the threshold value, where the first type of read operation includes a first level of decoding that is greater than a second level of decoding associated with a second type of read operation. The reading component 345 may be configured as or otherwise support a means for reading the data from the one or more multiple-level memory cells using the first type of read operation.

In some examples, the determination component 330 may be configured as or otherwise support a means for determining that the characteristic associated with the word line fails to satisfy the threshold value. In some examples, the selecting component 335 may be configured as or otherwise support a means for selecting the second type of read operation in response to determining that the characteristic associated with the word line fails to satisfy the threshold value. In some examples, the reading component 345 may be configured as or otherwise support a means for reading the data from the one or more multiple-level memory cells using the second type of read operation. In some examples, the decoding component 355 may be configured as or otherwise support a means for decoding the data read from the one or more multiple-level memory cells using the second level of decoding.

In some examples, the determination component 330 may be configured as or otherwise support a means for determining that the data read from the one or more multiple-level memory cells using the second type of read operation includes one or more errors in response to decoding the data using the second level of decoding. In some examples, the decoding component 355 may be configured as or otherwise support a means for decoding the data using the first level of decoding in response to determining that the data includes the one or more errors.

In some examples, the decoding component 355 may be configured as or otherwise support a means for decoding the data read from the one or more multiple-level memory cells using the first level of decoding.

In some examples, to support selecting the first type of read operation, the issuing component 350 may be configured as or otherwise support a means for issuing, by the memory system, a command to select the first type of decoding when reading the data from the one or more multiple-level memory cells using the first type of read operation.

In some examples, the characteristic associated with the word line includes a bit-error rate associated with the word line, a charge loss associated with the word line, or both.

In some examples, to support determining whether the characteristic associated with the word line satisfies the threshold value, the reading component 345 may be configured as or otherwise support a means for reading a value from a register of a volatile memory of the memory system.

In some examples, to support determining whether the characteristic associated with the word line satisfies the threshold value, the comparison component 360 may be configured as or otherwise support a means for comparing the bit-error rate associated with the word line to the threshold value, where the threshold value is associated with a quantity of bit-error rates. In some examples, to support determining whether the characteristic associated with the word line satisfies the threshold value, the comparison component 360 may be configured as or otherwise support a means for comparing the charge loss associated with the word line to the threshold value, where the threshold value is associated with a change in electrical charge over time.

In some examples, the first level of decoding is configured to correct a greater quantity of errors than the second type of read operation.

In some examples, the data is read from the one or more multiple-level memory cells using the first type of read operation during a first duration that is greater than a second duration associated with reading the data from the one or more multiple-level memory cells using the second type of read operation.

In some examples, the one or more multiple-level memory cells include triple-level cells (TLCs) or quad-level cells (QLCs).

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 320, or various components thereof, may be implemented at least in part by instructions (e.g., stored in memory, non-transitory computer-readable medium) executable by such at least one processor.

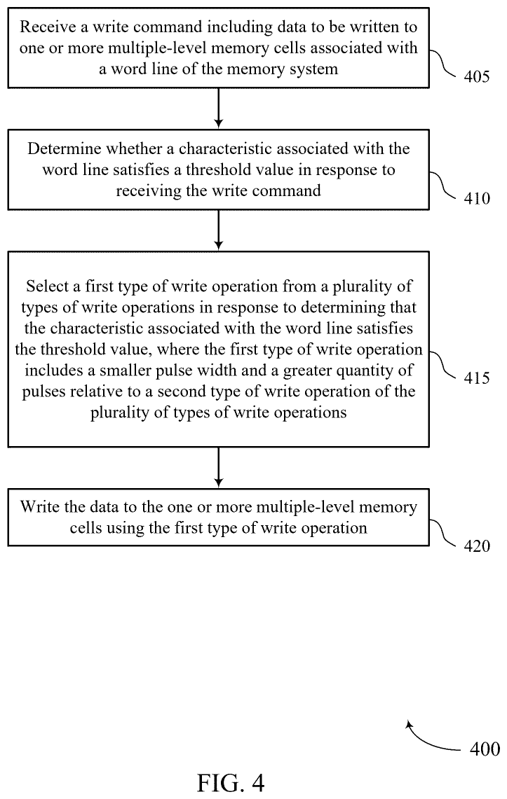

FIG. 4 shows a flowchart illustrating a method 400 that supports access operations on weak word lines in accordance with examples as disclosed herein. The operations of method 400 may be implemented by a memory system or its components as described herein. For example, the operations of method 400 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 405, the method may include receiving a write command including data to be written to one or more multiple-level memory cells associated with a word line of the memory system. In some examples, aspects of the operations of 405 may be performed by a reception component 325 as described with reference to FIG. 3.

At 410, the method may include determining whether a characteristic associated with the word line satisfies a threshold value in response to receiving the write command. In some examples, aspects of the operations of 410 may be performed by a determination component 330 as described with reference to FIG. 3.

At 415, the method may include selecting a first type of write operation from a plurality of types of write operations in response to determining that the characteristic associated with the word line satisfies the threshold value, where the first type of write operation includes a smaller pulse width and a greater quantity of pulses relative to a second type of write operation of the plurality of types of write operations. In some examples, aspects of the operations of 415 may be performed by a selecting component 335 as described with reference to FIG. 3.

At 420, the method may include writing the data to the one or more multiple-level memory cells using the first type of write operation. In some examples, aspects of the operations of 420 may be performed by a writing component 340 as described with reference to FIG. 3.

In some examples, an apparatus as described herein may perform a method or methods, such as the method 400. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a write command including data to be written to one or more multiple-level memory cells associated with a word line of the memory system; determining whether a characteristic associated with the word line satisfies a threshold value in response to receiving the write command; selecting a first type of write operation from a plurality of types of write operations in response to determining that the characteristic associated with the word line satisfies the threshold value, where the first type of write operation includes a smaller pulse width and a greater quantity of pulses relative to a second type of write operation of the plurality of types of write operations; and writing the data to the one or more multiple-level memory cells using the first type of write operation.

Aspect 2: The method, apparatus, or non-transitory computer-readable medium of aspect 1, further including operations, features, circuitry, logic, means, or instructions, or any combination thereof for receiving a first read command for the data written to the one or more multiple-level memory cells; selecting a first type of read operation from a plurality of types of read operations in accordance with the characteristic associated with the word line satisfying the threshold value, where the first type of read operation includes a first level of decoding that is greater than a second level of decoding associated with a second type of read operation; and reading the data from the one or more multiple-level memory cells using the first type of read operation.

Aspect 3: The method, apparatus, or non-transitory computer-readable medium of any of aspects 1 through 2, further including operations, features, circuitry, logic, means, or instructions, or any combination thereof for determining that the characteristic associated with the word line fails to satisfy the threshold value; selecting the second type of write operation in response to determining that the characteristic associated with the word line fails to satisfy the threshold value, where the second type of write operation includes a larger pulse width and a lesser quantity of pulses relative to the first type of write operation; and writing the data to the one or more multiple-level memory cells using the second type of write operation.

Aspect 4: The method, apparatus, or non-transitory computer-readable medium of aspect 3, further including operations, features, circuitry, logic, means, or instructions, or any combination thereof for receiving a second read command for the data written to the one or more multiple-level memory cells; selecting a second type of read operation from a plurality of types of read operations in accordance with the characteristic associated with the word line failing to satisfy the threshold value, where the second type of read operation includes a second level of decoding that is lesser than a first level of decoding associated with a first type of read operation; and reading the data from the one or more multiple-level memory cells using the second type of read operation.

Aspect 5: The method, apparatus, or non-transitory computer-readable medium of any of aspects 1 through 4, where selecting the first type of write operation includes operations, features, circuitry, logic, means, or instructions, or any combination thereof for issuing, by the memory system, a command to write the data to the one or more multiple-level memory cells using the first type of write operation.

Aspect 6: The method, apparatus, or non-transitory computer-readable medium of any of aspects 1 through 5, where the characteristic associated with the word line includes a bit-error rate associated with the word line, or a charge loss associated with the word line, or both.

Aspect 7: The method, apparatus, or non-transitory computer-readable medium of aspect 6, where determining whether the characteristic associated with the word line satisfies the threshold value includes operations, features, circuitry, logic, means, or instructions, or any combination thereof for reading a value from a register of a volatile memory of the memory system.

Aspect 8: The method, apparatus, or non-transitory computer-readable medium of any of aspects 6 through 7, where determining whether the characteristic associated with the word line satisfies the threshold value includes operations, features, circuitry, logic, means, or instructions, or any combination thereof for comparing the bit-error rate associated with the word line to the threshold value, where the threshold value is associated with a quantity of bit-error rates and comparing the charge loss associated with the word line to the threshold value, where the threshold value is associated with a change in electrical charge over time.

Aspect 9: The method, apparatus, or non-transitory computer-readable medium of any of aspects 1 through 8, where the data is written to the one or more multiple-level memory cells using the first type of write operation during a first duration that is greater than a second duration associated with writing data to the one or more multiple-level memory cells using the second type of write operation.

Aspect 10: The method, apparatus, or non-transitory computer-readable medium of any of aspects 1 through 9, where the one or more multiple-level memory cells include triple-level cells (TLCs) or quad-level cells (QLCs).

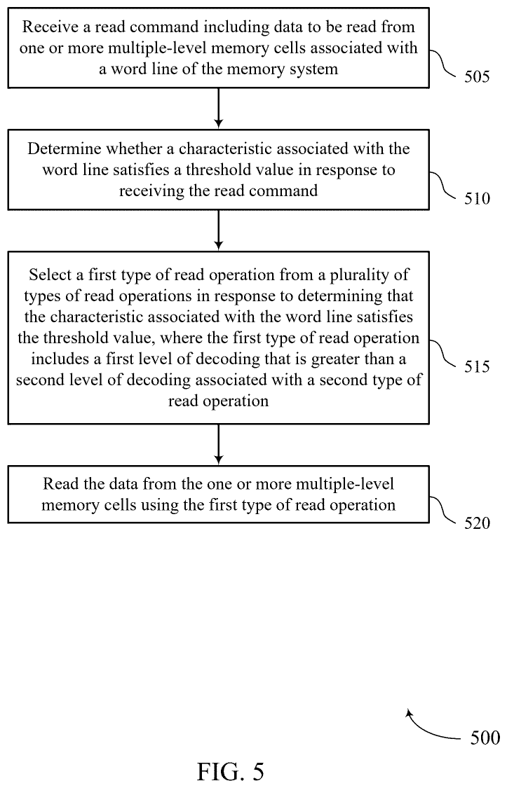

FIG. 5 shows a flowchart illustrating a method 500 that supports access operations on weak word lines in accordance with examples as disclosed herein. The operations of method 500 may be implemented by a memory system or its components as described herein. For example, the operations of method 500 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 505, the method may include receiving a read command including data to be read from one or more multiple-level memory cells associated with a word line of the memory system. In some examples, aspects of the operations of 505 may be performed by a reception component 325 as described with reference to FIG. 3.

At 510, the method may include determining whether a characteristic associated with the word line satisfies a threshold value in response to receiving the read command. In some examples, aspects of the operations of 510 may be performed by a determination component 330 as described with reference to FIG. 3.

At 515, the method may include selecting a first type of read operation from a plurality of types of read operations in response to determining that the characteristic associated with the word line satisfies the threshold value, where the first type of read operation includes a first level of decoding that is greater than a second level of decoding associated with a second type of read operation. In some examples, aspects of the operations of 515 may be performed by a selecting component 335 as described with reference to FIG. 3.

At 520, the method may include reading the data from the one or more multiple-level memory cells using the first type of read operation. In some examples, aspects of the operations of 520 may be performed by a reading component 345 as described with reference to FIG. 3.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 11: A method, apparatus, or non-transitory computer-readable medium including operations, features, circuitry, logic, means, or instructions, or any combination thereof for receiving a read command including data to be read from one or more multiple-level memory cells associated with a word line of the memory system; determining whether a characteristic associated with the word line satisfies a threshold value in response to receiving the read command; selecting a first type of read operation from a plurality of types of read operations in response to determining that the characteristic associated with the word line satisfies the threshold value, where the first type of read operation includes a first level of decoding that is greater than a second level of decoding associated with a second type of read operation; and reading the data from the one or more multiple-level memory cells using the first type of read operation.

Aspect 12: The method, apparatus, or non-transitory computer-readable medium of aspect 11, further including operations, features, circuitry, logic, means, or instructions, or any combination thereof for determining that the characteristic associated with the word line fails to satisfy the threshold value; selecting the second type of read operation in response to determining that the characteristic associated with the word line fails to satisfy the threshold value; reading the data from the one or more multiple-level memory cells using the second type of read operation; and decoding the data read from the one or more multiple-level memory cells using the second level of decoding.

Aspect 13: The method, apparatus, or non-transitory computer-readable medium of aspect 12, further including operations, features, circuitry, logic, means, or instructions, or any combination thereof for determining that the data read from the one or more multiple-level memory cells using the second type of read operation includes one or more errors in response to decoding the data using the second level of decoding and decoding the data using the first level of decoding in response to determining that the data includes the one or more errors.

Aspect 14: The method, apparatus, or non-transitory computer-readable medium of any of aspects 11 through 13, further including operations, features, circuitry, logic, means, or instructions, or any combination thereof for decoding the data read from the one or more multiple-level memory cells using the first level of decoding.

Aspect 15: The method, apparatus, or non-transitory computer-readable medium of any of aspects 11 through 14, where selecting the first type of read operation includes operations, features, circuitry, logic, means, or instructions, or any combination thereof for issuing, by the memory system, a command to select the first type of decoding when reading the data from the one or more multiple-level memory cells using the first type of read operation.

Aspect 16: The method, apparatus, or non-transitory computer-readable medium of any of aspects 11 through 15, where the characteristic associated with the word line includes a bit-error rate associated with the word line, a charge loss associated with the word line, or both.

Aspect 17: The method, apparatus, or non-transitory computer-readable medium of aspect 16, where determining whether the characteristic associated with the word line satisfies the threshold value includes operations, features, circuitry, logic, means, or instructions, or any combination thereof for reading a value from a register of a volatile memory of the memory system.

Aspect 18: The method, apparatus, or non-transitory computer-readable medium of any of aspects 16 through 17, where determining whether the characteristic associated with the word line satisfies the threshold value includes operations, features, circuitry, logic, means, or instructions, or any combination thereof for comparing the bit-error rate associated with the word line to the threshold value, where the threshold value is associated with a quantity of bit-error rates and comparing the charge loss associated with the word line to the threshold value, where the threshold value is associated with a change in electrical charge over time.

Aspect 19: The method, apparatus, or non-transitory computer-readable medium of any of aspects 11 through 18, where the first level of decoding is configured to correct a greater quantity of errors than the second type of read operation.

Aspect 20: The method, apparatus, or non-transitory computer-readable medium of any of aspects 11 through 19, where the data is read from the one or more multiple-level memory cells using the first type of read operation during a first duration that is greater than a second duration associated with reading the data from the one or more multiple-level memory cells using the second type of read operation.

Aspect 21: The method, apparatus, or non-transitory computer-readable medium of any of aspects 11 through 20, where the one or more multiple-level memory cells include triple-level cells (TLCs) or quad-level cells (QLCs).

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The term “layer” or “level” used herein refers to a stratum or sheet of a geometrical structure (e.g., relative to a substrate). Each layer or level may have three dimensions (e.g., height, width, and depth) and may cover at least a portion of a surface. For example, a layer or level may be a three dimensional structure where two dimensions are greater than a third, e.g., a thin-film. Layers or levels may include different elements, components, and/or materials. In some examples, one layer or level may be composed of two or more sublayers or sublevels.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.c., majority carriers are electrons), then the FET may be referred to as an n-type FET. If the channel is p-type (i.c., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (c.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.c., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a write command comprising data to be written to one or more multiple-level memory cells associated with a word line of the memory system;
determine whether a characteristic associated with the word line satisfies a threshold value in response to receiving the write command;
select a first type of write operation from a plurality of types of write operations in response to determining that the characteristic associated with the word line satisfies the threshold value, wherein the first type of write operation comprises a smaller pulse width and a greater quantity of pulses relative to a second type of write operation of the plurality of types of write operations; and
write the data to the one or more multiple-level memory cells using the first type of write operation.

2. The memory system of claim 1, wherein the processing circuitry is further configured to cause the memory system to:
receive a first read command for the data written to the one or more multiple-level memory cells;
select a first type of read operation from a plurality of types of read operations in accordance with the characteristic associated with the word line satisfying the threshold value, wherein the first type of read operation comprises a first level of decoding that is greater than a second level of decoding associated with a second type of read operation; and
read the data from the one or more multiple-level memory cells using the first type of read operation.

3. The memory system of claim 1, wherein the processing circuitry is further configured to cause the memory system to:
determine that the characteristic associated with the word line fails to satisfy the threshold value;
select the second type of write operation in response to determining that the characteristic associated with the word line fails to satisfy the threshold value, wherein the second type of write operation comprises a larger pulse width and a lesser quantity of pulses relative to the first type of write operation; and
write the data to the one or more multiple-level memory cells using the second type of write operation.

4. The memory system of claim 3, wherein the processing circuitry is further configured to cause the memory system to:
receive a second read command for the data written to the one or more multiple-level memory cells;
select a second type of read operation from a plurality of types of read operations in accordance with the characteristic associated with the word line failing to satisfy the threshold value, wherein the second type of read operation comprises a second level of decoding that is lesser than a first level of decoding associated with a first type of read operation; and
read the data from the one or more multiple-level memory cells using the second type of read operation.

5. The memory system of claim 1, wherein to select the first type of write operation, the processing circuitry is configured to cause the memory system to:
issue, by the memory system, a command to write the data to the one or more multiple-level memory cells using the first type of write operation.

6. The memory system of claim 1, wherein the characteristic associated with the word line comprises a bit-error rate associated with the word line, or a charge loss associated with the word line, or both.

7. The memory system of claim 6, wherein to determine whether the characteristic associated with the word line satisfies the threshold value, the processing circuitry is configured to cause the memory system to:
read a value from a register of a volatile memory of the memory system.

8. The memory system of claim 6, wherein to determine whether the characteristic associated with the word line satisfies the threshold value, the processing circuitry is configured to cause the memory system to:
compare the bit-error rate associated with the word line to the threshold value, wherein the threshold value is associated with a quantity of bit-error rates; or
compare the charge loss associated with the word line to the threshold value, wherein the threshold value is associated with a change in electrical charge over time.

9. The memory system of claim 1, wherein the data is written to the one or more multiple-level memory cells using the first type of write operation during a first duration that is greater than a second duration associated with writing data to the one or more multiple-level memory cells using the second type of write operation.

10. The memory system of claim 1, wherein:
the one or more multiple-level memory cells comprise triple-level cells (TLCs) or quad-level cells (QLCs).

11. A memory system, comprising:
one or more memory devices; and
processing circuitry coupled with the one or more memory devices and configured to cause the memory system to:
receive a read command comprising data to be read from one or more multiple-level memory cells associated with a word line of the memory system;
determine whether a characteristic associated with the word line satisfies a threshold value in response to receiving the read command;
select a first type of read operation from a plurality of types of read operations in response to determining that the characteristic associated with the word line satisfies the threshold value, wherein the first type of read operation comprises a first level of decoding that is greater than a second level of decoding associated with a second type of read operation; and
read the data from the one or more multiple-level memory cells using the first type of read operation.

12. The memory system of claim 11, wherein the processing circuitry is further configured to cause the memory system to:
determine that the characteristic associated with the word line fails to satisfy the threshold value;
select the second type of read operation in response to determining that the characteristic associated with the word line fails to satisfy the threshold value;
read the data from the one or more multiple-level memory cells using the second type of read operation; and
decode the data read from the one or more multiple-level memory cells using the second level of decoding.

13. The memory system of claim 12, wherein the processing circuitry is further configured to cause the memory system to:
determine that the data read from the one or more multiple-level memory cells using the second type of read operation comprises one or more errors in response to decoding the data using the second level of decoding; and
decode the data using the first level of decoding in response to determining that the data comprises the one or more errors.

14. The memory system of claim 11, wherein the processing circuitry is further configured to cause the memory system to:
decode the data read from the one or more multiple-level memory cells using the first level of decoding.

15. The memory system of claim 11, wherein to select the first type of read operation, the processing circuitry is configured to cause the memory system to:
issue, by the memory system, a command to select the first type of decoding when reading the data from the one or more multiple-level memory cells using the first type of read operation.

16. The memory system of claim 11, wherein the characteristic associated with the word line comprises a bit-error rate associated with the word line, a charge loss associated with the word line, or both.

17. The memory system of claim 16, wherein to determine whether the characteristic associated with the word line satisfies the threshold value, the processing circuitry is configured to cause the memory system to:
read a value from a register of a volatile memory of the memory system.

18. The memory system of claim 16, wherein to determine whether the characteristic associated with the word line satisfies the threshold value, the processing circuitry is configured to cause the memory system to:
compare the bit-error rate associated with the word line to the threshold value, wherein the threshold value is associated with a quantity of bit-error rates; or
compare the charge loss associated with the word line to the threshold value, wherein the threshold value is associated with a change in electrical charge over time.

19. The memory system of claim 11, wherein the first level of decoding is configured to correct a greater quantity of errors than the second type of read operation.

20. The memory system of claim 11, wherein the data is read from the one or more multiple-level memory cells using the first type of read operation during a first duration that is greater than a second duration associated with reading the data from the one or more multiple-level memory cells using the second type of read operation.

21. The memory system of claim 11, wherein:
the one or more multiple-level memory cells comprise triple-level cells (TLCs) or quad-level cells (QLCs).

22. A non-transitory computer-readable medium storing code comprising instructions which, when executed by one or more processors of a memory system, cause the memory system to:
receive a write command comprising data to be written to one or more multiple-level memory cells associated with a word line of the memory system;
determine whether a characteristic associated with the word line satisfies a threshold value in response to receiving the write command;
select a first type of write operation from a plurality of types of write operations in response to determining that the characteristic associated with the word line satisfies the threshold value, wherein the first type of write operation comprises a smaller pulse width and a greater quantity of pulses relative to a second type of write operation of the plurality of types of write operations; and
write the data to the one or more multiple-level memory cells using the first type of write operation.

23. The non-transitory computer-readable medium of claim 22, wherein the instructions, when executed by the one or more processors of the memory system, further cause the memory system to:
receive a first read command for the data written to the one or more multiple-level memory cells;
select a first type of read operation from a plurality of types of read operations in accordance with the characteristic associated with the word line satisfying the threshold value, wherein the first type of read operation comprises a first level of decoding that is greater than a second level of decoding associated with a second type of read operation; and
read the data from the one or more multiple-level memory cells using the first type of read operation.

24. The non-transitory computer-readable medium of claim 22, wherein the instructions, when executed by the one or more processors of the memory system, further cause the memory system to:
determine that the characteristic associated with the word line fails to satisfy the threshold value;
select the second type of write operation in response to determining that the characteristic associated with the word line fails to satisfy the threshold value, wherein the second type of write operation comprises a larger pulse width and a lesser quantity of pulses relative to the first type of write operation; and
write the data to the one or more multiple-level memory cells using the second type of write operation.

25. The non-transitory computer-readable medium of claim 24, wherein the instructions, when executed by the one or more processors of the memory system, further cause the memory system to:
receive a second read command for the data written to the one or more multiple-level memory cells;
select a second type of read operation from a plurality of types of read operations in accordance with the characteristic associated with the word line failing to satisfy the threshold value, wherein the second type of read operation comprises a second level of decoding that is lesser than a first level of decoding associated with a first type of read operation; and
read the data from the one or more multiple-level memory cells using the second type of read operation.
